(19) United States
(12) Patent Application Publication
(10) Pub. No.: US 2002/0076049 A1
(43) Pub. Date: Jun. 20, 2002

(54) Method for distributing perceptually encrypted videos and decypting them

(76) Inventors: Patrick Oscar Boykin, Raleigh, NC (US); Riccardo Boscolo, Culver City, CA (US); Walter Edward Johansen III, Santa Monica, CA (US)

Correspondence Address: W. Edward Johansen, 11661 San Vicente Boulevard, Los Angeles, CA, 90049, US

(21) Appl. No.: 09/740,717

(22) Filed: Dec. 19, 2000

(51) Int. Cl. H04N 7/167

(52) U.S. Cl. 380/211; 725/31

(57) ABSTRACT

A distributing system includes an encoder, a perceptual encryption module and a server. The encoder encodes the file of high quality video as encoded data in MP3 format. The encoded file has a plurality of frames. Each frame has a header with a sync and side information and main information. The perceptual encryption module perceptually encrypts the encoded data in MP3 format to generate restricted video data as perceptually encrypted encoded data. The server with a memory bank stores and distributes the perceptually encrypted encoded data. A receiving system receiving system includes a receiver with a memory bank, a perceptual decryption module and a decoder. The receiver receives and stores the perceptually encrypted encoded data. The perceptual decryption module perceptually decrypts the perceptually encrypted encoded data to generate encoded data in MP3 format. The decoder decodes the file of encoded data in MP3 format to generate high quality video.

### BACKGROUND OF THE INVENTION

The invention relates to perceptual encryption of high quality compressed video sequences and distribution thereof.

The invention also relates to files of high quality video and high fidelity audio data as encoded data in MP3 format and more particularly to perceptual encryption of the files of high quality video and high fidelity audio to generate files of restricted video and restricted audio data as perceptually encrypted encoded data in MP3 format. The files of restricted video and restricted fidelity audio data can either be decoded and played as restricted video and restricted fidelity audio or be perceptually decrypted with the use of a key, decoded and played as high quality video and high fidelity audio.

Current technologies for copyright protection of digital media are based on a full encryption of the encoded sequence, which does not allow the user any access to the data, unless a decryption key is made available. Alternative approaches to ensure rights protection are based on “watermarking” techniques, which aim to uniquely identify the source of a particular digital object thanks to a specific signature hidden in the bit stream, but invisible to the user.

The distribution of movies for viewing in the home is one of the largest industries in the world. The rental and sale of movies on videotape is a constantly growing industry amounting to over $15 billion dollars in software sales in the United States in 1995. The most popular medium for distributing movies to the home is by standard VHS videotape although other formats and mediums are available. One of the reasons for the robust market for movies on videotape is the established base of videocassette recorders in peoples homes. This helps fuel an industry of local videotape rental and sale outlets around the country and worldwide. The VHS videotape format is the most popular videotape format in the world and the longevity of this standard is assured due to the sheer numbers of VHS videocassette players installed worldwide. However, there are other mediums for distributing movies such as laser disk and 8 mm tape. In the near future, Digital Versatile Disk (DVD) technology will probably replace some of the currently used mediums since a higher quality of video and audio would be available through digital encoding on such a disk. Yet another medium for distributing movies to the home is through cable television networks currently providing pay-per-view capabilities and in the near future, direct video on-demand. For the consumer, the experience of renting or buying a video-tape is often frustrating due to the unavailability of the desired titles. Movie rental and sales statistics show that close to 50% of all consumers visiting a video outlet store do not find the title that they desire and either end up renting or buying an alternate title or not purchasing anything at all. This is due to the limited space for stocking many movie titles within the physical confines of the store. With limited inventory, video stores can only supply the most popular titles or a small number of select titles. Increasing the inventory of movie titles is in direct proportion to the shelf capacity of any one video store. Direct video distribution to the home is also limited by the availability of select and limited titles at predefined times. Pay-per-view services typically play a limited fare of titles at predefined times offering the consumer a very short list of options for movie viewing in the home. Video on-demand to the home is limited by the cable television head end facilities in its capacity to store a limited number of titles locally. All of the aforementioned mechanisms for distributing movies to the consumer suffer from inventory limitations. An untapped demand in movie distribution results if the inventory to the consumer can be made large enough and efficient enough to produce movies-on-demand in whatever format the consumer desires. There is a need in the art, therefore, for the ability to deliver movies on-demand with a virtually unlimited library of movies on any number of mediums such as VHS videotape, 8 mm videotape, recordable laser disk or DVD technology. Some systems have addressed the need for distribution of digital information for local manufacturing, sale and distribution.

U.S. Pat. No. 5,909,638 teaches system which captures, stores and retrieves movies recorded in a video format and stored in a compressed digital format at a central distribution site. Remote distribution locations are connected through fiber optic connections to the central distribution site. The remote sites maybe of one of two types: a video retail store or a cable television (CATV) head end. In the case of a video retail store, VHS videotapes, other format videotapes or other video media may be manufactured on-demand in as little as three to five minutes for rental or sell-through. In a totally automated manufacturing system the customers can preview and order movies for rental and sale from video kiosks. The selected movie is then either retrieved from local cache storage or downloaded from the central distribution site for manufacturing onto a blank or reused videotape. One feature of the system is the ability to write a two-hour videotape into a Standard Play (SP) format using a high-speed recording device. A parallel compression algorithm based on the MPEG-2 format is used to compress a full-length movie into a movie data file of approximately four gigabytes of storage. The movie data file can be downloaded from the central site to the remote manufacturing site and written onto a standard VHS tape using a parallel decompression engine to write the entire movie at high speeds onto a standard VHS tape in approximately three minutes.

U.S. Pat. No. 5,793,980 teaches an audio-on-demand communication system which provides real-time playback of audio data transferred via telephone lines or other communication links. One or more audio servers include memory banks which store compressed audio data. At the request of a user at a subscriber PC, an audio server transmits the compressed audio data over the communication link to the subscriber PC. The subscriber PC receives and decompresses the transmitted audio data in less than real-time using only the processing power of the CPU within the subscriber PC. High quality audio data compressed according to loss-less compression techniques is transmitted together with normal quality audio data. Meta-data, or extra data, such as text, captions, still images, etc., is transmitted with audio data and is simultaneously displayed with corresponding audio data. The audio-on-demand system also provides a table of contents indicating significant divisions in the audio clip to be played and allows the user immediate access to audio data at the listed divisions. Servers and subscriber PCs are dynamically allocated based upon geographic location to provide the highest possible quality in the communication link.

U.S. Pat. No. 5,949,411 teaches a system for previewing movies, videos, music, and other events, has a host data processing network connected via modem with one or more media companies and with one or more remote kiosks to transmit data between the media companies and the kiosks, so that the data can be accessed by users at the remote kiosks. A touch screen and user-friendly graphics encourage use of the system. Video images, graphics and other data received from the media companies are suitably digitized, compressed, and otherwise formatted by the host for use at the kiosk. This enables movies, videos, music and special events to be previewed at strategically located kiosks, and the data can be updated or changed, as desired, from the host.

U.S. Pat. No. 6,119,138 teaches an improved apparatus and method which are provided for wireless communication with computers. The communication apparatus is integrated with a removable by cover of a computer case and operatively connected to memory means associated with the case. By either mounting or affixing the wireless communication device to a bay or slot cover in the computer case, conventional existing computers can be readily retrofitted to include integral and upgradable wireless communication. A jack or other connection is provided in the bay or slot cover, and a removable wireless communication member is selectively connected to the jack. Cable means preferably connect a motherboard within the computer housing to the wireless communication device. The wireless communication device or connection may be combined on a single bay cover with a conventional device such as a diskette drive, tape drive, or the like.

U.S. Pat. No. 5,608,606 teaches a computer which includes a connector for coupling wireless technologies to a computer. The connector includes a card connector and a matting internal connector cage/frame. The card connector provides a RF connector positioned above a 68 pin connector, which provides a connection to radio frequency (RF) signals. A card has devices which support RF operations for the computer. The card connector is attached to the card and interfaces with the devices on the card. The housing of the computer defines a card slot which receives the card and guides connection of the card with the computer by mating the card connector with the internal connector.

U.S. Pat. No. 4,975,926 teaches an intra-office communication system as the final communication link of a broadband, base-band, or fiber optic LAN. Each user or workstation is a node on the network and can transmit at high data rates with bit error rates of <=10-9 in packets through the LAN. Message relaying transponders are placed on the ceiling and walls communicating by electromagnetic waves to individual workstations by broadcast. A novel multi-path rejection scheme is combining transponder placements with pseudo-noise coding for robust and secure data transmission. For the present state of the art if infrared is used, we estimate a minimum light collecting aperture (receive antenna) of 1 cm2 for transmission rates of 30 to 100 Mb/s.

U.S. Pat. No. 6,069,588 teaches a through-the-window coaxial coupler which co-axially couples Radio Frequency (RF) signals between the inside and outside surfaces of a window. The through-the-window coaxial coupler includes an inside portion that mounts on the inside surface of a window, and an outside portion that mounts on the outside surface of the window and couples to an outside antenna. An inside electronic package couples to the inside portion of the through-the-window coaxial coupler, and is located adjacent the inside portion and remote from a radiotelephone. The inside electronic package includes a receive amplifier that amplifies RF signals that are received from the outside antenna via the through-the-window coaxial coupler and that provides the RF signals so amplified to the radiotelephone. The inside electronic package may include a wireless transceiver and that wirelessly transmits and receives signals to and from a radiotelephone. Thus, only power may need to be supplied to the electronic package, but signal and/or connections may be provided to the radiotelephone using wireless communications. One such wireless communications protocol that may be used is the well known “Bluetooth” protocol that defines a universal radio interface in the 2.45 GHz frequency band that enables wireless electronic devices to connect and communicate wirelessly via short-range, ad hoc networks. Radiotelephones are widely used for wireless voice and/or data communications. As used herein, the term “radio-telephone” includes analog and digital radiotelephones, multiple mode radiotelephones, high function Personal Communications Systems (PCS) devices that may include large displays, scanners, full size keyboards and the like, wireless Personal Digital Assistants (PDA) and other devices, such as personal computers that are equipped with wireless modems and other wireless electronic devices. It may be increasingly difficult to efficiently couple an antenna to a radiotelephone transceiver. In particular, in many radiotelephone applications, the radiotelephone is located within an enclosure such as a vehicle or a building. However, it may be desirable to include the antenna outside the enclosure in order to provide adequate link margin. For example, in radiotelephone communications involving radio links between a mobile vehicle and a communication satellite, it is generally desirable for the antenna to be outside the vehicle. It is also generally desirable to have a radio frequency receiver unit near the antenna in order to allow an improved receiver antenna gain to receiver system temperature ratio. Moreover, as a practical matter, it also may be desirable to include a transmitter power amplifier near the antenna, to overcome transmission loss between the antenna and the transceiver. It is known to provide an external electronic package or module adjacent an antenna outside a vehicle window, to thereby improve the performance of a radiotelephone within a vehicle. Unfortunately, external electronic packages may be subject to environmental hazards and damage by vandals. Other hazard potentials include automatic car washing facilities that can damage external electronic packages. Moreover, it may be difficult to couple an electronic package outside the window to a radiotelephone inside the vehicle. It may be unacceptable to cut holes in the widow or other parts of the vehicle body. The running of coaxial cables through doorjambs may not be acceptable. Accordingly, although outdoor antenna units that combine an antenna and an electronic package have been used in the trucking industry or in marine applications (such as the INMARSAT-C system), it may be generally undesirable for terrestrial cellular and satellite radiotelephone communications systems such as the Iridium, Globalstar and ACeS systems. It is also known to allow a radiotelephone antenna to be used within an enclosure such as a building or a vehicle. While this solution may be acceptable for many cellular radiotelephone communications, it may not be desirable for satellite radiotelephone communications which may have low link margins and which preferably operate in a direct line of sight path between the radiotelephone and the communications satellite.

U.S. Pat. No. 5,963,916 teaches a system for on-line user-interactive multimedia based point-of-preview. The system provides for a network web site and accompanying software and hardware for allowing users to access the web site over a network such as the internet via a computer. The user is uniquely identified to the web site server through an identification name or number. The hardware associated with the web site includes storage of discrete increments of pre-selected portions of music products for user selection and preview. After user selection, a programmable data processor selects the particular prerecorded music product from data storage and then transmits that chosen music product over the network to the user for preview. Subscriber selection and profile data (i.e. demographic information) can optionally be collected and stored to develop market research data. The system contemplates previewing of audio programs such as music on compact discs, video programs such as movies and text from books and other written documents. Furthermore, it is contemplated that the network web site can be accessed from a publicly accessible kiosk, available, e.g. at a retail store location, or from a desk-top computer.

U.S. Pat. No. 6,105,131 teaches a distribution system. The distribution system includes a server.

U.S. Pat. No. 5,636,276 teaches a distribution system. The distribution system distributes music information in digital form from a central memory device via a communications network to a terminal.

U.S. Pat. No. 5,008,935 teaches a method for encrypting data for storage in a computer and/or for transmission to another data processing system.

Stimulated by the technological revolution in both, networking technology, such as the Internet, and highly efficient perceptual audio coding methods such as MPEG-1 Layer-3, commonly referred to as MP3, a tremendous amount of music piracy has emerged. There have been many attempts to combat music piracy.

In one such attempt an audio scrambler has been developed. The audio scrambler operates by encrypting selected parts of an encoded audio bit-stream instead of encrypting entire data blocks. These protected parts represent spectral values of the audio signal. As a result, decoding of a protected bit-stream without a decrypter and a key will produce a distorted and annoying audio signal. A consequence of this scheme is that the decryption cannot be separated from the decoding. The audio scrambler has a high degree of security, because a deep knowledge of the bit-stream structure is needed to reach the protected parts. The low complexity of this scheme makes it possible to implement the audio scrambler on real-time decoding systems like portable devices without substantially increasing the computational workload.

In another such attempt the Secure Digital Music Initiative group has developed industry standards which it hopes will not only enable music distribution via the Internet, but also ensure the proper honoring of all intellectual property rights which is associated with the delivered content. One of the most important technical means for achieving this goal are secure envelope techniques which package the content into a secure container by means of ciphering all or part of the payload with well-known encryption techniques. In this way, access to the payload can be restricted to authorized persons. Such protection schemes can be applied to any kind of digital data. However, the versatility of these schemes implies that the secured data must first be decrypted before subsequent decoding.

U.S. Pat. No. 6,081,794 teaches a data copyright management system in which a primary user edits a received data and supplies the edited data to a secondary user. The copyright management system includes a database and a key control center.

U.S. Pat. No. 5,818,933 teaches a copyright controller which performs access control to copyright digital information. The copyright controller is equipped with decryption hardware. The decryption hardware accepts encrypted copyright digital information and decrypts the encrypted digital information using a decryption key obtained from a copyright control center.

U.S. Pat. No. 6,038,316 teaches an information processing system which includes an encryption module and a decryption module for enabling the encryption of digital information to be decrypted with a decryption key. The encryption module includes logic for encrypting the digital information and distributing the digital information. The decryption module includes logic for the user to receive a key. The decryption logic then uses the key to make the content available to the user.

U.S. Pat. No. 5,949,876 teaches a system for secure transaction management and electronic rights protection. Computers are equipped to ensure that information is accessed and used only in authorized ways and to maintain the integrity, availability and/or confidentiality of the information.

U.S. Pat. No. 6,052,780 teaches a digital information protection system which allows a content provider to encrypt digital information without requiring either a hardware or platform manufacturer or a content consumer to provide support for the specific form of corresponding decryption. Suitable authorization procedures also enable the digital information to be distributed for a limited number of uses and/or users, thus enabling per-use fees to be charged for the digital information.

In 1987, the IIS started to work on perceptual audio coding in the framework of the EUREKA project EU147, Digital Audio Broadcasting. In a joint cooperation with the University of Erlangen, the IIS finally devised a very powerful algorithm which is standardized as ISO-MPEG Audio Layer-3 (IS 11172-3 and IS 13818-3). Without data reduction, digital audio signals typically consist of 16 bit samples recorded at a sampling rate more than twice the actual audio bandwidth such as 44.1 kHz for Compact Disks. More than 1.400 Megabit would be required to represent just one second of stereo music in compact disk quality. By using MPEG audio coding, the original sound data from a compact disk may be shrunk by a factor of 12, without losing sound quality. Factors of 24 and even more still maintain a sound quality that is significantly better than what can be gotten by just reducing the sampling rate and the resolution of the audio samples. Basically, this is realized by perceptual coding techniques addressing the perception of sound waves by the human ear. By exploiting stereo effects and by limiting the audio bandwidth, the coding schemes may achieve an acceptable sound quality at even lower bit-rates. MPEG-1 Layer-3 is the most powerful member of the MPEG audio coding family for a given sound quality level, either it requires the lowest bit-rate or for a given bit-rate it achieves the highest sound quality.

Using MPEG-1 audio, one may achieve a typical data reduction of 1 to 10 to 12 by Layer 3 which corresponds with 128.112 kilobits per second for a stereo signal, still maintaining the original COMPACT DISK sound quality. By exploiting stereo effects and by limiting the audio bandwidth, the coding schemes may achieve an acceptable sound quality at even lower bit-rates. MPEG-1 Layer-3 is the most powerful member of the MPEG audio coding family. For a given sound quality level, it requires the lowest bit-rate—or for a given bit-rate, it achieves the highest sound quality. In listening tests, MPEG Layer-3 impressively proved its superior performance, maintaining the original sound quality at a data reduction of 1:12 (around 64 kbit/s per audio channel). If applications may tolerate a limited bandwidth of around 10 kHz, a reasonable sound quality for stereo signals can be achieved even at a reduction of 1:24.

For the use of low bit-rate audio coding schemes in broadcast applications at bit-rates of 60 kilobit per second per audio channel, the ITU-R recommends MPEG Layer-3. The filter bank used in MPEG Layer-3 is a hybrid filter-bank which consists of a poly-phase filter bank and a Modified Discrete Cosine Transform (MDCT). This hybrid form was chosen for reasons of compatibility to its predecessors.

The perceptual model is mainly determining the quality of a given encoder implementation. It uses either a separate filter bank or combines the calculation of energy values for the masking calculations and the main filter bank. The output of the perceptual model consists of values for the masking threshold or the allowed noise for each encoder partition. If the quantization noise can be kept below the masking threshold, then the compression results should be indistinguishable from the original signal. Joint stereo coding takes advantage of the fact that both channels of a stereo channel pair contain far the same information. These stereophonic irrelevancies and redundancies are exploited to reduce the total bit-rate. Joint stereo is used in cases where only low bit-rates are available but stereo signals are desired. A system of two nested iteration loops is the common solution for quantization and coding in a Layer-3 encoder. Quantization is done via a power-law quantizer. In this way, larger values are automatically coded with less accuracy and some noise shaping is already built into the quantization process. The quantized values are coded by Huffman coding. As a specific method for entropy coding, Huffman coding is loss-less. Thus is called noiseless coding because no noise is added to the audio signal. The process to find the optimum gain and scale factors for a given block, bit-rate and output from the perceptual model is usually done by two nested iteration loops in an analysis-by-synthesis way.

The Huffman code tables assign shorter code words to (more frequent) smaller quantized values. If the number of bits resulting from the coding operation exceeds the number of bits available to code a given block of data, this can be corrected by adjusting the global gain to result in a larger quantization step size, leading to smaller quantized values This operation is repeated with different quantization step sizes until the resulting bit demand for Huffman coding is small enough. The loop is called rate loop because it modifies the overall encoder rate until it is small enough. To shape the quantization noise according to the masking threshold, scale-factors are applied to each scale-factor band. The system starts with a default factor of 1.0 for each band. If the quantization noise in a given band is found to exceed the masking threshold (allowed noise) as supplied by the perceptual model, the scale-factor for this band is adjusted to reduce the quantization noise. Since achieving a smaller quantization noise requires a larger number of quantization steps and thus a higher bit rate, the rate adjustment loop has to be repeated every time new scale factors are used. In other words, the rate loop is nested within the noise control loop. The outer noise control loop is executed until the actual noise, which is computed from the difference of the original spectral values minus the quantized spectral values, is below the masking threshold for every scale-factor band. There is often a lot of confusion surrounding the terms audio compression, audio encoding, and audio decoding. Up to the advent of audio compression, high-quality digital audio data took a lot of hard disk space to store or channel band-with to transmit. Let us go through a short example. A user wants to sample his favorite 1-minute song and stores it on his hard disk. Because he wants compact disk quality, the samples at 44.1 kHz, stereo, with 16 bits per sample, using 44.100 Hz means that he has 44.100 values per second coming in from either the sound card or the input file, multiplying that by two because there are two channels, multiplying by another factor of two because there are two bytes per value (that's what 16 bit means). The song will take up 44.100 samples per second times 2 channels times2 bytes per sample times 60 seconds per minute which equals around 10 Megabytes of storage space on a hard disk. If the user wanted to download that over the internet, given an average 28.8 modem, it would take 10.000.000 bytes times 8 bits/byte/times 28.800 bits per second times 60 seconds per minute which equals around 49 minutes in order to download one minute of stereo music. Digital audio coding, which is synonymously called digital audio compression, is the art of minimizing storage space (or channel bandwidth) requirements for audio data. Modern perceptual audio coding techniques exploit the properties of the human ear, the perception of sound, to achieve a size reduction by a factor of 12 with little or no perceptible loss of quality. Therefore, such schemes are the key technology for high quality low bit-rate applications, like soundtracks for CD-ROM games, solid-state sound memories, Internet audio, digital audio broadcasting systems, and the like. The end result after encoding and decoding is not the same sound file anymore as all superfluous information has been squeezed out. This superfluous information is the redundant and irrelevant parts of the sound signal. The reconstructed WAVE file differs from the original WAVE file, but it will sound the same, more or less, depending on how much compression had been performed on it. Because compression ratio is a somewhat unwieldy measure, experts use the term bit-rate when speaking of the strength of compression. Bit-rate denotes the average number of bits that one second of audio data will consume. The usually units here are kbps, 1000 bits per second. For a digital audio signal from a compact disk, the bit-rate is 1411.2 kbps. With MPEG-2 AAC, compact disk-like sound quality is achieved at 96 kbps.

Audio compression really consists of two parts. The first part, called encoding, transforms the digital audio data that resides, say, in a WAVE file, into a highly compressed form called bit-stream (or coded audio data). To play the bit-stream on your soundcard, you need the second part, called decoding. Decoding takes the bit-stream and reconstructs it to a WAVE file. Highest coding efficiency is achieved with algorithms exploiting signal redundancies and irrelevancies in the frequency domain based on a model of the human auditory system.

All encoders use the same basic structure. The encoding scheme can be described as “perceptual noise shaping” or “perceptual sub-band/transform coding”. The encoder analyzes the spectral components of the audio signal by calculating a filter-bank (transform) and applies a psycho-acoustics model to estimate the just noticeable noise-level. In its quantization and coding stage, the encoder tries to allocate the available number of data bits in a way to meet both the bit-rate and masking requirements. The decoder is much less complex. Its only task is to synthesize an audio signal out of the coded spectral components. The term psycho-acoustics describes the characteristics of the human auditory system on which modern audio coding technology is based. The sensitivity of the human auditory systems for audio signals is one of its most significant characteristics. It varies in the frequency domain. The sensitivity of the human auditory system is high for frequencies between 2.5 and 5 kHz and decreases beyond and below this frequency band. The sensitivity is represented by the Threshold In Quiet. Any tone below this threshold will not be perceived. The most important psycho-acoustics fact is the masking effect of spectral sound elements in an audio signal like tones and noise. For every tone in the audio signal a masking threshold can be calculated. If another tone lies below this masking threshold, it will be masked by the louder tone and remains inaudible, too. These inaudible elements of an audio signal are irrelevant for the human perception and thus can be eliminated by the encoder.

For the audio quality of a coded and decoded audio signal the quality of the psycho-acoustics model used by an audio encoder is of prime importance. The audio coding schemes developed by Fraunhofer engineers belong to the best worldwide.

U.S. Pat. No. 5,579,430 teaches a digital encoding process for transmitting and/or storing acoustical signals and, in particular, music signals, in which scanned values of the acoustical signal are transformed by means of a transformation or a filter bank into a sequence of second scanned values, which reproduce the spectral composition of the acoustical signal, and the sequence of second scanned values is quantized in accordance with the requirements with varying precision and is partially or entirely encoded by an optimum encoder, and in which a corresponding decoding and inverse transformation takes place during the reproduction. An encoder is utilized in a manner in which the occurrence probability of the quantized spectral coefficient is correlated to the length of the code in such a way that the more frequently the spectral coefficient occurs, the shorter the code word. A code word and, if needed, a supplementary code is allocated to several elements of the sequence or to a value range in order to reduce the size of the table of the encoder. A portion of the code words of variable length are arranged in a raster, and the remaining code words are distributed in the gaps still left so that the beginning of a code word can be more easily found without completely decoding or in the event of faulty transmission.

U.S. Pat. No. 5,848,391 teaches a method of encoding time-discrete audio signals which includes the steps of weighting the time-discrete audio signal by means of window functions overlapping each other so as to form blocks, the window functions producing blocks of a first length for signals varying weakly with time and blocks of a second length for signals varying strongly with time. A start window sequence is selected for the transition from windowing with blocks of the first length to windowing with blocks of the second length, whereas a stop window sequence is selected for the opposite transition. The start window sequence is selected from at least two different start window sequences having different lengths, whereas the stop window sequence is selected from at least two different stop window sequences having different lengths. A method of decoding blocks of encoded audio signals selects a suitable inverse transformation as well as a suitable synthesis window as a reaction to side information associated with each block.

U.S. Pat. No. 5,812,672 teaches a method which reduces data during the transmission and/or storage of the digital signals of several dependent channels in which the dependence of the signals in the channels, e.g. in a left and a right stereo channel, can be used for an additional data reduction. Instead of known methods such as middle/side encoding or the intensity stereo process that lead to perceptible interference in the case of an unfavourable signal composition, the method avoids such interference, in that a common encoding of the channels only takes place if there is an adequate spectral similarity of the signals in the two channels. An additional data reduction can be achieved in that in those frequency ranges where the spectral energy of a channel does not exceed a pre-determinable fraction of the total spectral energy, the associated spectral values are set at zero.

U.S. Pat. No. 5,742,735 teaches a digital adaptive transformation coding method for the transmission and/or storage of audio signals, specifically music signals in which N scanned values of the audio signal are transformed into M spectral coefficients, and the coefficients are split up into frequency groups, quantized and then coded. The quantized maximum value of each frequency group is used to define the coarse variation of the spectrum. The same number of bits is assigned to all values in a frequency group. The bits are assigned to the individual frequency groups as a function of the quantized maximum value present in the particular frequency group. A multi-signal processor system is disclosed which is specifically designed for implementation of this method.

U.S. Pat. No. 6,101,475 teaches in a method for the cascaded coding and decoding of audio data the spectral components of the short-time spectrum associated with a data block are formed for each data block with a certain number of time input data, the coded signal is formed, by quantization and coding, on the basis of the spectral components for this data block and using a psycho-acoustic model to determine the bit distribution for the spectral components, whereupon time output data are obtained by decoding at the end of each codec stage. To prevent a deterioration in the sound quality in codec cascades with a plurality of stages, an identification code is added to the coded signal at an initial stage to mark the start of the data block; furthermore, the subsequent codec stages divide the data blocks to be coded on the basis of this identification

U.S. Pat. No. 6,097,843 teaches a compression encoding apparatus for compression encoding an inputted image signal in accordance with a rule of the MPEG or the like, other compression and decompression different from a main compression encoding which is executed by a motion detection/compensation processing circuit, a discrete cosine transforming/quantizing circuit, and a Huffman encoding circuit are executed. The compression and decompression are executed by a signal compressing circuit and a signal decompressing circuit. As mentioned above, by reducing an amount of information that is written into a memory provided in association with the compression encoding apparatus, a capacity of the memory can be decreased. By executing other compression and decompression different from a decoding process corresponding to the compression encoding to a decoding apparatus according to the rule of the MPEG or the like, a capacity of a memory provided in association with the decoding apparatus can be reduced.

U.S. Pat. No. 6,064,748 teaches an apparatus for embedding and retrieving an additional data bit-stream in an encoded data stream, such as MPEG. The embedded data is processed and a choice parameter in the header portion of the encoded data stream is varied according to the embedded information bit pattern. Optimization of the encoded data stream is not significantly affected. The embedded information is robust in that the encoded data stream would need to be decoded and re-encoded in order to change a bit of the embedded information. As relevant portions of the header are not scrambled to facilitate searching and navigation through the encoded data stream, the embedded data can generally be retrieved even when the encoded data stream is scrambled.

U.S. Pat. No. 6,115,689 teaches an encoder/decoder system which includes an encoder and a decoder. The encoder includes a multi-resolution transform processor, such as a modulated lapped transform (MLT) transform processor, a weighting processor, a uniform quantizer, a masking threshold spectrum processor, an entropy encoder, and a communication device, such as a multiplexor (MUX) for multiplexing (combining) signals received from the above components for transmission over a single medium. The decoder includes inverse components of the encoder, such as an inverse multi-resolution transform processor, an inverse weighting processor, an inverse uniform quantizer, an inverse masking threshold spectrum processor, an inverse entropy encoder, and an inverse MUX. The encoder is capable of performing resolution switching, spectral weighting, digital encoding, and parametric modeling.

U.S. Pat. No. 5,890,112 teaches an audio encoding device. The audio encoding device includes an analyzing unit for conducting frequency analyses of an input audio signal, a bit weighting unit for generating a weight signal based on an analysis signal, and a filter for converting an input audio signal into a plurality of frequency band signals. The audio encoding device also has a bit allocating unit for generating quantization data from a frequency band signal based on a value of a weight signal, and a frame packing unit for generating compression data from quantization data and outputting the compression data. A frame completion determining unit determines whether weight allocation processing is normally completed or not, and a storage unit stores the last weight signal recognized as having weight allocation processing normally completed. Further, a switching unit supplies the bit allocating unit with a weight signal stored in the storage unit in place of a weight signal generated by the bit weighting unit according to the determination results of the frame completion determining unit.

U.S. Pat. No. 6,112,219 teaches a fast discrete cosine transform and a fast inverse discrete cosine transform in a software implementation. The method exploits symmetries found in both the DCT and IDCT. As a result of the symmetries found in the DCT and IDCT, both transforms may be performed using a combination of look-up tables and butterfly operations, thus employing only a small number of additions and subtractions and no multiplications.

U.S. Pat. No. 5,742,599 teaches a method which supports constant bit rate encoded MPEG-2 transport over local Asynchronous Transfer Mode (ATM) networks. The method encapsulates constant bit rate encoded MPEG-2 transport packets, which are 188 bytes is size, in an ATM AAL-5 Protocol Data Unit (PDU), which is 65,535 bytes in size. The method and system includes inserting a plurality of MPEG-2 transport packets into a single AAL-5 PDU, inserting a segment trailer into the ATM packet after every two MPEG packets, and then inserting an ATM trailer at the end of the ATM packet. In the method 10 or 12 MPEG-2 transport packets are packed into one AAL-5 PDU to yield a throughput 70.36 and 78.98 Mbits/sec, respectively, thereby supporting fast forward and backward playing of MPEG-2 movies via ATM networks.

U.S. Pat. No. 5,970,461 teaches a method which provides an inverse transform for an audio compression decoding algorithm in software which pre-calculates a plurality of identified values. Each value is computationally intensive. The method and system then performs a pre-inverse transform complex multiply utilizing a first portion of the identified values and an array of input coefficients to provide a plurality of intermediate values. Thereafter, an inverse transform complex multiply and a post inverse transform multiply are combined to provide a combined complex multiply operation. The combined complex multiply operation uses a second portion of the identified values and the intermediate values provides the inverse transform.

U.S. Pat. No. 6,157,625 teaches in an MPEG transport stream, each audio signal packet is placed after the corresponding video signal packet when audio and video transport streams are multiplexed. If simple switching were made to switch between a plurality of programs to form a multiplexed transport stream of the programs, part of the audio packets that are placed behind would be lost to cause abnormal sound. In the invention, switching between programs is made by providing signal switching means separately for audio transport streams and video transport streams. As a result, when the program to be transmitted is changed from one program to another, the signal switching means can be switched in such a manner that none of the audio signal packets that constitute those programs are lost.

U.S. Pat. No. 6,157,674 teaches an apparatus which compresses and codes audio and/or video data by the MPEG2 system or the like, multiplexing the same, and transmitting the resultant data via a digital line. When generating a transport stream for transmitting a PES packet of the MPEG2 system, the amounts of the compressed video data and the compressed audio data are defined as whole multiples of the amount of the transport packet (188 bytes) of the MPEG2 system, thereby to bring the boundary of the frame cycle of the audio and/or video data and the boundary of the transport packet into coincidence. Where the amount of data is arbitrary, calculation etc. of the offset value which becomes necessary at the scheduling is made unnecessary.

U.S. Pat. No. 6,092,107 teaches a system which allows the adaptation of a non-adaptive system for playing/browsing coded audiovisual objects, such as the parametric system of MPEG-4.

U.S. Pat. No. 5,418,713 teaches a system for on-demand data delivery and reproduction of program material at a remote site. In this system a central site stores digitized information such as digital video game information which can be downloaded to a manufacturing site for storage onto a blank video game cartridge. The manufactured game cartridge can be ordered on-demand from a large variety of titles and delivered to the consumer within a matter of minutes. The shortcomings of the system is the inability to download and manufacture or distribute large volumes of digital information such as would be required for the downloading, distribution or manufacturing of fall motion, full length video movies.

The inventor incorporates the teachings of the above-cited patents into this specification.

### SUMMARY OF THE INVENTION

The present invention is generally directed to a distribution system and a receiving system. The distribution system distributes a file of video and audio data and which includes a video source, an audio source, an encoder and a server. The video source may be a digital video disk and a player. The audio source may be a compact disk and a player. The players generate a video signal and an audio signal. The encoder encodes the video and audio signals in order to generate files of video and audio data as encoded data in MP3 format. The server either stores or distributes the file of video and audio data as encoded data in MP3 format. The file of video audio data as encoded data in MP3 format has a plurality of frames. Each frame has a header with a sync and side information and main information. The receiving system includes a personal computer, a decoder and a player.

In a first separate aspect of the present invention, the distribution system also includes a perceptual encrypter and the video and audio signals are a high quality video signal and a high fidelity audio signal, respectively. The encoder encodes the high quality video signal and the high fidelity audio signal in order to generate files of high quality video and high fidelity audio data as encoded data in MP3 format. The perceptual encrypter perceptually encrypts the files of high quality video and high fidelity audio data as encoded data in MP3 format in order to generate files of restricted quality video and restricted fidelity audio data as perceptually encrypted encoded data in MP3 format.

In a second separate aspect of the present invention, the distribution system also includes a fidelity parameter module. The fidelity parameter module adjusts fidelity parameters in order to determine what data in the files of restricted video and restricted fidelity audio data as perceptually encrypted encoded data in MP3 format is to be encrypted.

In a third separate aspect of the present invention, the decoder decodes the file of restricted video and restricted fidelity audio data as perceptually encrypted encoded data in MP3 format so that it may be played as restricted video and restricted fidelity audio signals.

In a fourth separate aspect of the present invention, the receiving system also includes a perceptual decryption module. The perceptual decryption module perceptually decrypts the file of restricted video and restricted fidelity audio data as perceptually encrypted encoded data in MP3 format in order to recreate the file of high quality video and high fidelity audio data as encoded data in MP3 format. The decoder decodes the file of high quality video and high fidelity audio data as encoded data in MP3 format so that it may be played as high quality video and high fidelity audio signals.

In a fifth separate aspect of the present invention, the perceptual decryption module uses a key in order to decrypt the file of restricted video and restricted fidelity audio data as perceptually encrypted encoded data in MP3 format.

Other aspects and many of the attendant advantages will be more readily appreciated as the same becomes better understood by reference to the drawing and the following detailed description.

The features of the present invention which are believed to be novel are set forth with particularity in the appended claims.

### DESCRIPTION OF THE DRAWINGS

FIG. 1 is a schematic drawing of the architecture of an encryption process according to the present invention.

FIG. 2 is a block diagram of the encryption process of FIG. 1.

FIG. 3 is a block diagram of the decryption process of FIG. 1.

### DESCRIPTION OF THE PREFERRED EMBODIMENT

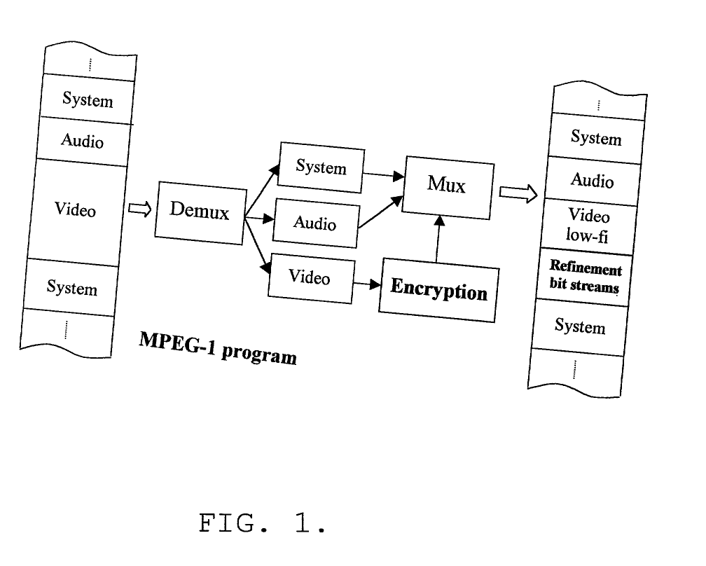

Referring to FIG. 1 an encryption process 10 encrypts high quality compressed video sequences for intellectual property rights protection purposes. The key part of the encryption process 10 resides in its capability of preserving the compatibility of the encrypted bit stream with the compression standard. This allows the distribution of encrypted video sequences with several available levels of video and audio quality coexisting in the same bit stream. The encryption process 10 permits the content provider to selectively grant the user access to a specific fidelity level without requiring the transmission of additional compressed data.

The real-time encryption/decryption process 10 for compressed video sequences preserves the compatibility of the encrypted sequences with the original standard used to encode the video and audio data. The main advantage of the encryption process 10 is that several levels of video quality can be combined in a single bit stream thereby allowing selective restriction access to the users. When compared to other common encryption strategies the proposed implementation presents the advantage of giving the user access to a “low fidelity” version of the audio-video sequence, instead of completely precluding the user from viewing the sequence.

Still referring to FIG. 1 the encryption process 10 is superior to full encryption because it allows simultaneous content protection and preview capabilities. It is also safer than watermarking since it prevents intellectual property rights infringement rather than trying to detect it after the fact. In a first embodiment the encryption process 10 is applied to video encoded under the MPEG-1 compression standard. The use of the encryption process 10 is not limited to this specific standard, but, rather, it is applicable to a large ensemble of audio/video compression standards2, including MPEG-2, MPEG-4, MPEG-21, MPEG-7, QuickTime, RealTime, AVI, CinePak, and others. The overall architecture for the encryption process 10 includes a multiplexed MPEG-1 program stream which is demultiplexed, separating audio, video and other additional packets. While audio and other non-video packets are simply buffered and then transferred to the output, the video packets are partially decoded and successively encrypted, according to a specific encryption strategy. The main idea behind the encryption process 10 is to decompose the video packets into several sub-packets: the first sub-packet provides the essential conformance to the standard and, in addition, contains enough information to guarantee a basic low-fidelity viewing capability of the video sequence. This sub-packet is not subject to encryption. The following sub-packets represent refinement bit streams that enhance the “quality” of the basic packet, all the way until a full fidelity video sequence is obtained. These packets are encrypted using standard cryptographic processes and are placed back in the bit stream as padding streams, which are ignored by the decoder. The definition of “successive levels of quality” is arbitrary and the proposed invention is not limited to a particular one. Possible definitions of level of fidelity could be associated, but are not restricted to, higher resolution, higher dynamic range, better color definition, lower signal-to-noise ratio (SNR), or better error resiliency.

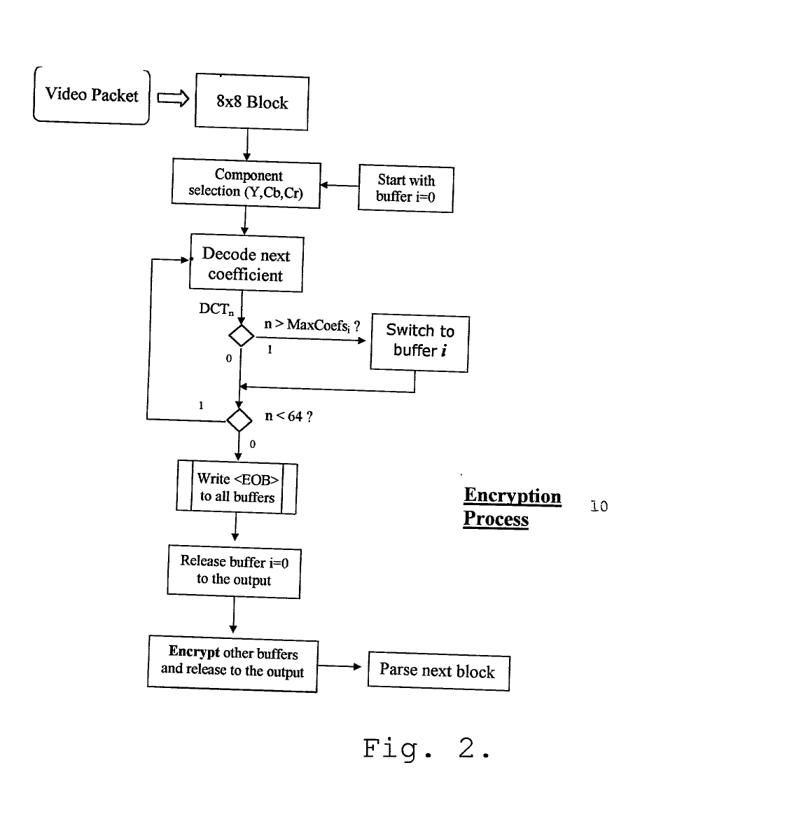

Referring to FIG. 2 most video encoding technologies take advantage of mainly two principles in order to achieve high compression rates. The first is the intrinsic data redundancy, which is reduced adopting suitable entropy coding processes 10. The other principle is based on the characteristics of the human visual system: here the basic idea is that it is not necessary to encode those features the human eye is not sensitive to. In general this principle translates into a bit allocation problem, where more bits are allocated to describe features more relevant to the human visual system.

Still referring to FIG. 2 this is achieved in the MPEG-1 standard through a combination of motion prediction (temporal redundancy) and Huffman coding of DCT (Discrete Cosine Transform) coefficients computed on 8×8 image areas (spatial redundancy). One of the most important features of the DCT is that it is particularly efficient in de-coupling the image data. As a consequence the resulting transformed blocks tend to have a covariance matrix that is almost diagonal, with small cross-correlation terms. The most relevant feature to our invention, though, is that each of the transform coefficients contains the information relative to a particular spatial frequency. As a consequence cutting part of the high frequency coefficients acts as a low-pass filter decreasing the image resolution.

The encoding strategy developed for the encryption process 10 consists in separating the spectral information contained in the video sequence across several packets and selectively encrypt each of the packets. This operation is performed both in the luminance as well as in the chrominance domain, permitting to generate a variety of encoded sequences with different properties. For example it allows building a video sequence where the basic low-fidelity mode permits the access to a grayscale video at low resolution. The user can then be granted access to the color or the higher resolution components to obtain a high fidelity video sequence. Most video encoding standard, in fact, are based on separation of the color components (RGB or YCbCr) and use spectral information to achieve high compression rates. The basic encoded unit in the MPEG-1 standard is represented by an 8×8 pixel region, where each pixel is described by a luminance term (Y) and two chrominance terms (Cb and Cr). The 8×8 DCT of each component is computed, returning 64 coefficients (per component) sorted in order of increasing spatial frequency. As the input bit stream is parsed, once a video packet is identified, its DCT coefficients are selectively sent to a specific buffer, according to the specific encryption strategy. The parameters MaxYCoeffsi, MaxCbCoeffsi and MaxCrCoeffsi allow to select the maximum number of Y, Cb and Cr coefficients, respectively, for each refinement bit stream i (i=0 is the main sub-packet, which is not encrypted). As soon as the maximum number of coefficients in a given sub-packet and a given component is reached, an end-of-block (EOB) code is appended to signal the end of the current block. This step is crucial since the Huffman encoded 8×8 blocks do not present any start-of-block marker and the EOB sequence is the only element signaling the termination of the compressed block and the beginning of the next.

Once the video packet parsing is completed, the first generated sub-packet is released to the output stream to replace the original video packet. The refinement packets are then encrypted using standard cryptographic processes and are successively released to the output as padding streams, i.e. as streams whose function is exclusively that of preserving the current bit rate. Since the size of the combined sub-packets is only slightly larger than the original video packet the bit rate of the original sequence is preserved and the decoding of the encrypted sequence does not require additional buffering capabilities.

Since the encryption process 10 acts on the video packets, as they are made available to the system, the encryption can be performed in real-time on a streaming video sequence with no delay. This result is a consequence of the fact that each video packet is encrypted separately and the refinement bit streams for a specific packet are streamed immediately following the non-encrypted low fidelity data. This feature of the encryption process is very attractive because it makes it suitable for real-time on demand streaming of encrypted video. Moreover keeping the encryption process 10 distributed gives the encoded sequences better error resiliency properties, allowing easier error correction.

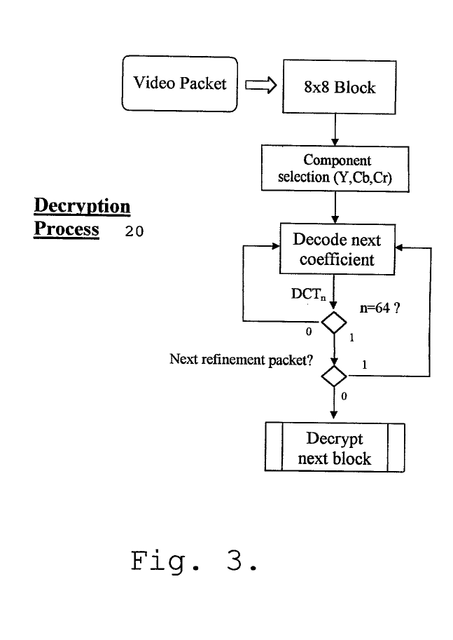

Referring to FIG. 3 no extra information related to the refinement sub-packets is added in order to keep the overhead introduced by the encryption process 10 as small as possible, to the video packet header. As a consequence the first task of the decryption operation is to search for encrypted video packets following the principal non-encrypted packet. A proprietary 4 bytes long code following the padding stream header signals the decryptor that a refinement packet is present.

Similarly to the encryption process 10, a decryption process 20 acts on one video packet at the time. Once the current video packet is buffered the system searches for refinement sub-packets that immediately follow the main packet. According to the level of access to the video sequence granted to the user, the available refinement bit streams are decrypted and are combined with the original packet. The fusion of the main packet with the refinement sub-packets takes place at the block level. In a preferred embodiment of the decryption process 20 only additional spectral information is contained in the refinement data. This implementation represents a possible example of definition of multiple level of access to the video sequence, but the decryption process 20 is not limited to a particular one.

In the implementation of the proposed system for the MPEG-1 standard, the encrypted bit streams contain refinement DCT coefficients whose function is to give access to a full-resolution high fidelity version of the video sequence. The fusion of the original block data with the refinement coefficients is possible with minimal overhead using the following process 10. Given an 8×8 image block, the Huffman codes of the main packet are decoded until an end-of-block sequence is reached. At this point the decryptor starts decoding the Huffman codes of the next refinement packet, if any is available. The DCT coefficients are then appended to the original sequence until the EOB sequence is read. The decryption process 20 continues until all the refinement packets are examined. In the special case of an additional sub-packet that does not contain any additional coefficient for the given 8×8 block, an EOB code is encountered immediately at the beginning of the block, signaling the decryptor that no further DCT coefficients are available.

Similarly to the encryption process 10 the decryption process 20 takes place independently on each video packet, allowing real-time operation on streaming video sequences. As soon as all the refinement sub-packets, following the principal packet, are received, the decryption process 20 can be completed.

From the foregoing it can be seen that video encryption/decryption processes and a video distribution system have been described.

Accordingly it is intended that the foregoing disclosure and drawings shall be considered only as an illustration of the principle of the present invention.

What is claimed is:

1. A video distribution system comprising:
a. a movie capture facility for capturing a movie content having a corresponding title and for producing therefrom digital data representing the movie content in the form of a movie data file;
b. a movie storage facility coupled to receive and store the movie data file;
c. a central host server coupled to the movie storage facility for cataloging a movie data file with the corresponding title and for retrieving the movie data file from the movie storage facility upon receipt of a transfer request;
d. a communications network coupled to the central host server for receiving the movie data file and for transmitting the movie data file over the communications network;
e. a remote server coupled to the communications network for receiving the movie data file;
f. a selection device coupled to the remote server for selecting the movie content for manufacture;
g. a production device coupled to the remote server and the selection device for reproducing the movie content from the movie data file; and
h. a decoding apparatus connected between the remote server and the production device and operable for receiving the movie data file, for parallel decompressing the movie data file and for producing therefrom a plurality of parallel bit streams of the digital data representing the movie content and the production device further operable for manufacturing the movie content from the parallel bit streams received from the decoding apparatus.

2. A distributing system for a file of high quality video, said distributing system comprising:
a. an encoder which encodes the file of high quality video as encoded data in MP3 format wherein the encoded file has a plurality of frames each of which has a header with a sync and side information and main information;
b. a perceptual encryption module which perceptually encrypts said encoded data in MP3 format to generate restricted video data as perceptually encrypted encoded data; and
c. a server with a memory bank which stores and distributes said perceptually encrypted encoded data.

3. A receiving system for a file of high quality video for use with said distributing system of claim 1 wherein said receiving system comprises:
a. a receiver with a memory bank which receives and stores said perceptually encrypted encoded data;
b. a perceptual decryption module coupled to said receiver wherein said perceptual decryption module perceptually decrypts said perceptually encrypted encoded data to generate encoded data in MP3 format; and
c. an decoder coupled to said perceptual encryption module wherein said decoder decodes the file of encoded data in MP3 format to generate high quality video.
